(19) United States
(12) Patent Application Publication
(10) Pub. No.: US 2026/0240112 A1
(43) Pub. Date: Aug. 20, 2026

(54) WASH STATION

(71) Applicant: Kohler Co., Kohler, WI (US)

(72) Inventors: Alexander James, Kohler, WI (US); Katherine McGlenn, Kohler, WI (US); John Adams, Kohler, WI (US); Richard Mead, Kohler, WI (US); Matt Bettencourt, Kohler, WI (US); Natalia Baltazar, Kohler, WI (US); Todd Leonhard, Kohler, WI (US); Nicole Summersett, Kohler, WI (US); Jonathan Bradley, Kohler, WI (US); Mark Ropella, Kohler, WI (US); Mark Van Wolvelaere, Kohler, WI (US); Peter Kajuch, Kohler, WI (US); Megen Rapp, Kohler, WI (US); Katerina Revelis, Kohler, WI (US); Jason Kwacz, Kohler, WI (US); Taiwoon Woon, Kohler, WI (US)

(21) Appl. No.: 19/541,013

(22) Filed: Feb. 16, 2026

Related U.S. Application Data
(60) Provisional application No. 63/759,788, filed on Feb. 18, 2025.
(60) Provisional application No. 63/862,449, filed on Aug. 12, 2025.

(51) Int. Cl. A01K 13/00; A01G 25/14; A01K 29/00

(52) U.S. Cl. CPC A01K 13/001; A01K 29/007; A01G 25/145

(57) ABSTRACT

One example pet wash station includes a handshower, a bath fixture, an adjustable grate configured to be adjusted to a plurality of heights with respect to the bath fixture, and a user input device configured to operate the handshower or the adjustable grate. One example utility wash station includes at least one side wall, a water supply coupled to the at least one side wall, a base having at least one drain opening, and a platform supported by the at least one side wall and configured to be operable in a washing position and a stowed position.

### CROSS REFERENCE TO RELATED APPLICATION

This application claims the benefit of priority to U.S. Provisional Application No. 63/759,788 filed on Feb. 18, 2025 and U.S. Provisional Application No. 63/862,449 filed on Aug. 12, 2025, which is hereby incorporated by reference in its entirety.

### FIELD

The present application relates generally a pet washing station and/or other water dispensing devices for animals.

### BACKGROUND

Washing a pet may be a messy experience. Placing a pet in a bathtub or basin often results in splashed water and muddy footprints in the vicinity of the bathtub. The pet may be washed with the hands of a person, which can be difficult to perform. Some of the following embodiments describe pet washing stations where one or more of the tasks involved in the pet washing process are automated or performed by an apparatus rather than manually by a person.

### BRIEF DESCRIPTION OF THE DRAWINGS

Exemplary embodiments are described herein with reference to the following drawings, according to an exemplary embodiment.

FIG. 1 illustrates an example handshower.

FIG. 2 illustrates an example handshower with multiple spray modes.

FIG. 3A-C illustrate example connections for the handshower.

FIG. 4 illustrates an example pet washing station.

FIG. 5 illustrates another example pet washing station.

FIGS. 6A and 6B illustrates another example pet washing station.

FIG. 7 illustrates another example pet washing station.

FIG. 8 illustrates an example pet washing kit.

FIG. 9 illustrates an example grate and separation drain.

FIG. 10 illustrates another example pet washing station.

FIG. 11 illustrates another example pet washing station.

FIG. 12 illustrates a water treatment control system for the pet washing station.

FIG. 13A illustrates a pet triggered faucet.

FIG. 13B illustrates a pet triggered water dispenser.

FIG. 14 illustrates a control system for any of the disclosed embodiments.

FIG. 15 illustrates an example flow chart for the controller of FIG. 13.

FIG. 16A-C illustrates a pet washing station with a folding platform.

FIGS. 17 and 18 illustrates an example pet washing station with a versatile washing platform.

FIG. 19A illustrates another example pet washing station with a grooming device.

FIG. 19B illustrates another example pet washing station with a food dispenser.

FIG. 20A illustrates another example pet washing station with a window.

FIG. 20B illustrates another example pet washing station with a pet operated washing device.

FIG. 21A illustrates another example pet washing station with a fountain.

FIG. 21B illustrates another example pet washing station with a pet operated paw washing device.

FIG. 22 illustrates an example flow chart for the pet washing station.

FIG. 23 illustrates a pet washing station with an independent water supply.

FIG. 24 illustrates a pet washing station with a recirculating water supply.

FIG. 25 illustrates an in-wall water distribution system.

FIG. 26 illustrates a walkthrough pet washing station.

FIG. 27 illustrates a walkthrough pet washing station.

FIG. 28 illustrates a pet tracking system.

FIG. 29 illustrates a pet dish tracking and monitoring system.

FIG. 30 illustrates a food and water dispensing system.

FIG. 31 illustrates modular configurations of the food and water dispensing system.

FIG. 32 illustrates an example flow chart for monitoring.

### DETAILED DESCRIPTION

The pet wash station is self-contained unit that is installed and plumbed (e.g., connected to water supply and drainage pipes in a plumbing system). It can be used in mudrooms, garages, basements, or any room inside that has water access. In addition, the pet wash station may be used outside such as in yards, decks, or patios. The pet wash station is designed to support ergonomic positioning of the animal and the human. The pet wash station may also reduce the consumption of water.

While the following embodiments are generally discussed with respect to pets, the wash stations are operable in a variety of other applications. Examples include gardening (e.g., watering potted plants), cleaning dishes (e.g., turkey roaster), cleaning craft supplies (e.g., paintbrushes), cleaning sports equipment, cleaning boots, and in any of the examples, a drying rack for the object.

A faucet and a hand shower provide filtered or otherwise treated water that can be adjusted to fit a variety of uses including washing animals, watering plants, or cleaning off equipment. The term “hand shower” may include any example flexible hose and water delivery nozzle. The term “hand shower” is not intended to limit the flow rate used in the pet wash station in any way. The hand shower as disclosed may include any flow rate including those in excess of 2.5 gallons per minute. The term “hand shower” as used herein may include hand operated sprayers. When washing animals, the hand shower works as previously described. The hand shower may have advanced water options including ozonated water that disinfects and cleans eliminating the need for soap. Another water option is microbubbles that help to scrub and clean without having to use bristles or combs. Another water option is electrolyzed water.

The floor of the pet washing station may include non-slip floor matt that is comfortable for paws. The floor shelf is adjustable and can be raised or lowered to provide comfortable position during use. Dogs can be secured using the handrail. The fur drain ensures that pipes are not clogged with dog fur.

Any of the following examples may be added to an existing shower. A hand shower may connect to standard shower arm. for example, the normal shower head may be coupled to the end of it, with a diverter to switch between the two. The handshower is configured for pet washing with brush head built into the shower head (potentially silicon bristles to reduce bacteria growth/make for easy cleaning).

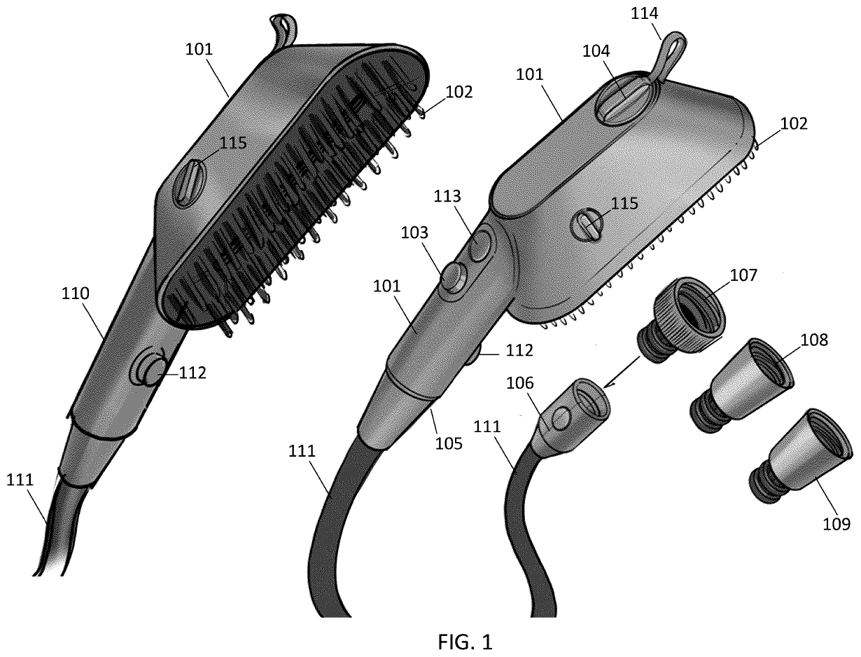

FIG. 1 illustrates an example handshower 101. The handshower 101 may be part of (e.g., connected to) pet washing stations described herein. The handshower 101 may also be used independently with any water source. The handshower 101 may include a one or more bristles 102, a soap button 103/113 for integrated soaping, a cap 104 for a soap reservoir, a drop detector 105, a quick connector 106, a handle 110, a hose 111, a trigger 112 to turn the water dispending ON and OFF, a hanging loop 114 that may mate with a hook to store the handshower 101, and a flow control knob 115. The soap button may include an ON button 103 to activate soaping and an OFF button 113 to deactivate soaping. The quick connector 106 may be configured to connect to various types of adapters such as a bath or shower adapter 107, a sink pull down adapter 108, and/or a garden hose adapter 109. Additional, different or fewer components may be included.

The drop detector 105 is an example automatic shutoff device configured to disable the handshower 101. The drop detector 105 may include a sensor such as an inertial measurement unit (IMU) that detects when the handshower 101 falls under the acceleration of gravity. The IMU may include one or more accelerometers or gyroscopes that generates one or more dimensions of position, velocity, or accelerometer data. The drop detector 105 may include an impact sensor that determines when the drop detector 105 contacts the ground or another surface such as the pet washing stations described herein. A controller or control circuit may identify when the sensor data exceeds a threshold that indicates the handshower 101 has been dropped or made impact. In response, the controller may generate a valve closing command that turns off the water supply of the handshower 101.

In another example, the drop detector 105 may include a spring or another mechanical device that is triggered when dropped. Impact causes the spring to be released, which pushes the valve closed that turns off the water supply of the handshower 101. The trigger 112 may be spring loaded such that the drop detector 105 causes the spring to release the trigger when the handshower 101 has been dropped or made impact.

The body of the handshower 101 may include at least one cavity to store soap (e.g., liquid soap). The soap cavity is connected to the washing face of the handshower 101 so that soap is dispensed through openings on or near bristles 102 as a soap dispenser. The soap button may include an ON button 103 that opens a soap valve that opens the soap openings and an OFF button 113 that closes the soap valve to close the soap openings.

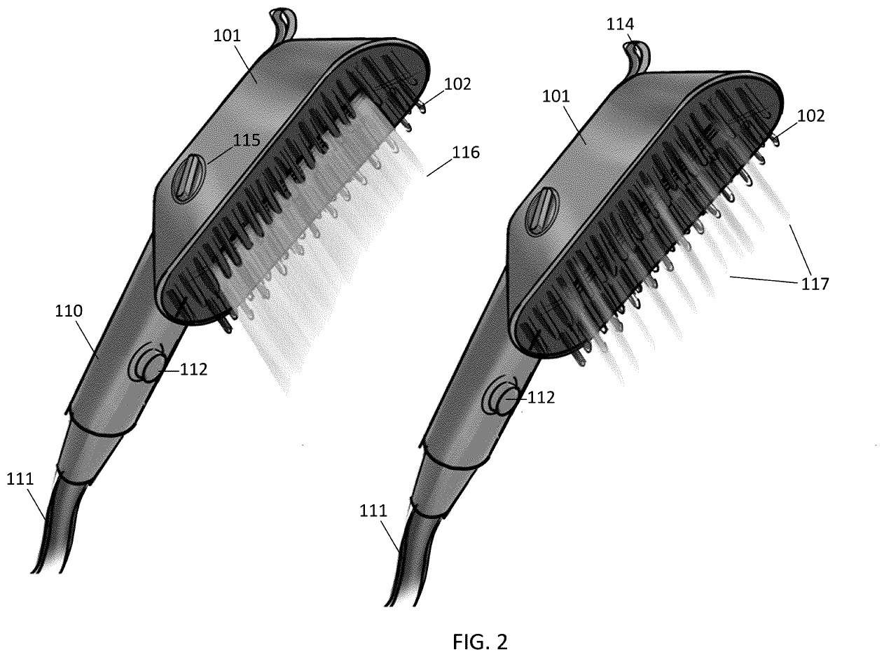

FIG. 2 illustrates an example handshower with multiple spray modes. Each spray mode may be defined according to a power of spray and a jet surface area. Each spray mode includes a different pattern of nozzles for dispensing water from the handshower 101. A sheet spray rinse 116 includes nozzles arranged in a linear or longitudinal pattern along a line. A rain shower spray 117 includes a dispersed pattern in an area so that nozzles are arranged in both a longitudinal and lateral direction. The nozzles of the rain shower spray 117 may be spaced farther apart than the nozzles of the sheet spray rinse 116.

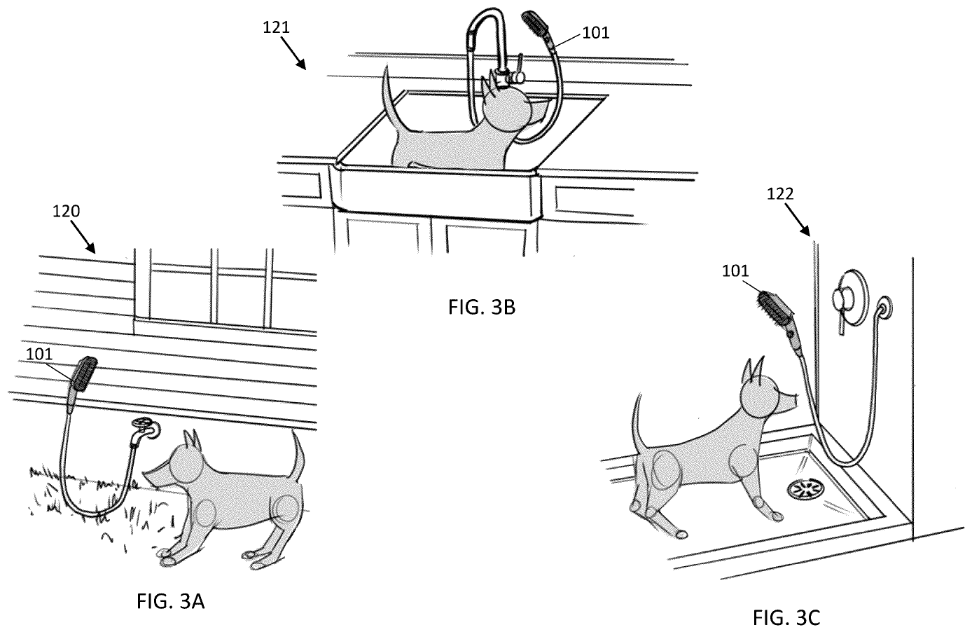

FIGS. 3A-C illustrate example connections for the handshower. FIG. 3A indicates that the handshower 101 may be connected to an outdoor spigot or a garden hose connector (e.g., garden hose adapter 109). FIG. 3B indicates that the handshower 101 may be connected to a faucet (e.g., a sink pull down adapter 108). FIG. 3C indicates that the handshower 101 may be connected to an existing shower or bath using a dedicated connector or another type of adapter (e.g., bath or shower adaptor 107). The handshower 101 may include nozzles that are arranged in a particular pattern. The handshower 101 may have a horseshoe shape with nozzles that can spray water simultaneously on the left side of the pet, the right side of the pet, and the top of the pet.

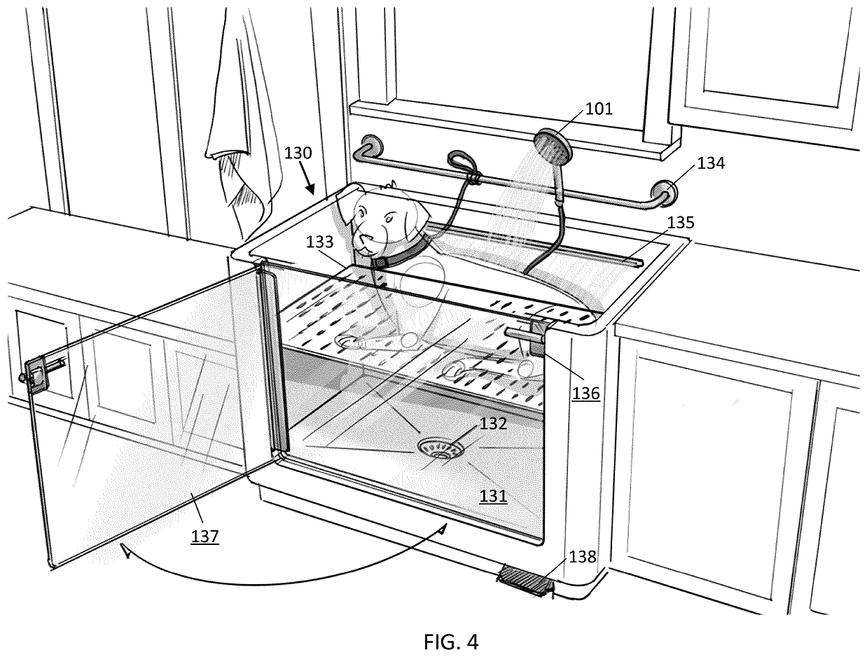

FIG. 4 illustrates an example pet washing station 130. The pet washing station 130 includes at least a bath fixture 131, a handshower 101 and an adjustable grate 133, which may be referred to as a floor or a platform. Additional components of the pet washing station 130 may include a user input device 138, a door 137, a fur drain 132 (e.g., separation drain), an additional water supply (e.g., water sheet supply 135). One or more components external to the pet washing station 130 may include a grab bar 134. Additional, different or fewer components may be included.

The bath fixture 131 is a watertight structure formed of a solid material. Example materials for the bath fixture 131 include acrylic, fiberglass, polyurethane, resin, stainless steel, or vitreous china. The material for the bath fixture 131 may be a sustainably sourced material. The bath fixture 131 may be formed in a mold using a curing process. The bath fixture 131 may have a base (e.g., floor) and a plurality of walls (e.g., four walls in the case of a rectangular cross-section and one wall in the case of circular or oval cross section). An opening for the fur drain 132 may be formed in the bath fixture 131. The bath fixture 131 wall(s) may extend to a predetermined height.

The door 137 may be mounted to one of the walls through a hinge. The height may be at least as high as the door 137. The height may correspond to the height of a pet. The door 137 may be opened so that the pet can easily enter the pet washing station 130. For example, rather than lifting the pet into a sink or bathtub, the door 137 is opened and the pet simply jumps or steps into the pet washing station 130. To comfort the pet during the washing experience, the door 137 may be formed of a transparent material such that the pet can set out of the pet washing station 130. This is true even If the adjustable grate 133 is lowered to the point where the eyes of the pet are below the top of the bath fixture 131. The transparent material for the door 137 may be glass, plastic, or another material.

The adjustable grate 133 may be sized to fit within and move within the bath fixture 131. The adjustable grate 133 includes one or more openings that passes water to the bottom of the bath fixture 131 (e.g., to drain 132). In some examples, the openings may also be large enough to pass fur, dirt, and/or other small objects to the bath fixture 131.

The adjustable grate 133 may be movable using a variety of techniques including manual devices, motorized devices, and automatic devices.

A manual device for adjustment of the adjustable grate 133 may include a handle for the user to grip the adjustable grate 133, a bolt or latch to lock the adjustable grate 133 in place. For example, the bolt or latch may be coupled to the adjustable grate 133. The bath fixture 131 may include a series of holes at various height settings for the adjustable grate 133. The holes may be implemented as a bracket with holes at various heights. The user may move the adjustable grate 133 to the various settings and slide the bolt or move the latch to mate with the bracket according to the desired height of the adjustable grate 133.

A motorized device for the adjustable grate 133 may include a motor, a solenoid, a hydraulic arm, or other powered device for lifting and/or lowering the adjustable grate 133. When the motor is energized and rotates, the adjustable grate 133 may be lifted using a cable, rack and pinion or other gear train. The adjustable grate 133 may be lowered by driving the motor in the other direction or through gravity or pressure from the user (e.g., pressing the adjustable grate 133 down). Similarly, a pump may push hydraulic fluid into the hydraulic arm in order to lift the adjustable grate 133. The flow of hydraulic fluid may be reversed to lower the adjustable grate 133. In another example, an electromagnetic solenoid may be energized to extend an arm or a lever to push the adjustable grate 133 to a predetermined height. The motor, the hydraulic pump, and/or the solenoid may be energized according to a command from a controller. In some examples, the controller may generate the commands based on an instruction received from user input 138.

The user input 138 may include a foot operated pedal, as shown in FIG. 4. The user input device 138 configured to operate the handshower 101 and the adjustable grate 133 at the same time. For example, press the pedal may open a valve that provides water to the handshower 101. The user input 138 is configured to operate the handshower in at least two modes such as the sheet spray rinse 116, firing nozzles arranged in a linear pattern, and a rain shower spray 117, firing nozzles in a dispersed (e.g., two dimensional) pattern.

Similarly, lifting the pedal (e.g., placing the foot under the pedal to lift the pedal) may cause the adjustable grate 133 to raise. In other examples, the user input device 138 may include one or more buttons (e.g., a first button may correspond to the valve for the handshower 101 and a second button may correspond to the adjustable grate 133).

Alternatively, the user input 138 ay include a button, keypad, touchscreen, or another data entry device mounted anywhere on the door 137 or the bath fixture 131. The user may enter a selection for the height of the adjustable grate 133 or the mode of the handshower 101 directly onto any of these data entry devices.

Optionally, the pet washing station 130 may include another internal water supply. For example, a water sheet supply 135 is installed on a side of the pet wash station 130. The water sheet supply 135 may be configured to release water in a sheet independently of the handshower 101. That is, the water sheet supply 135 may be controller by the user input 138 (e.g, foot pedal or date entry device). In other examples, the water sheet supply 135 is on when the handshower 101 is activated by the trigger button 112.

In some example, the pet washing station 130 may extend to an entire room. Sprayers may be mounted on the ceiling. The drain 132 may be incorporated with the floor. The adjustable grate 133 may be mounted in a portion of the room (e.g., a corner). The doors of the room may include seals to prevent water leakage.

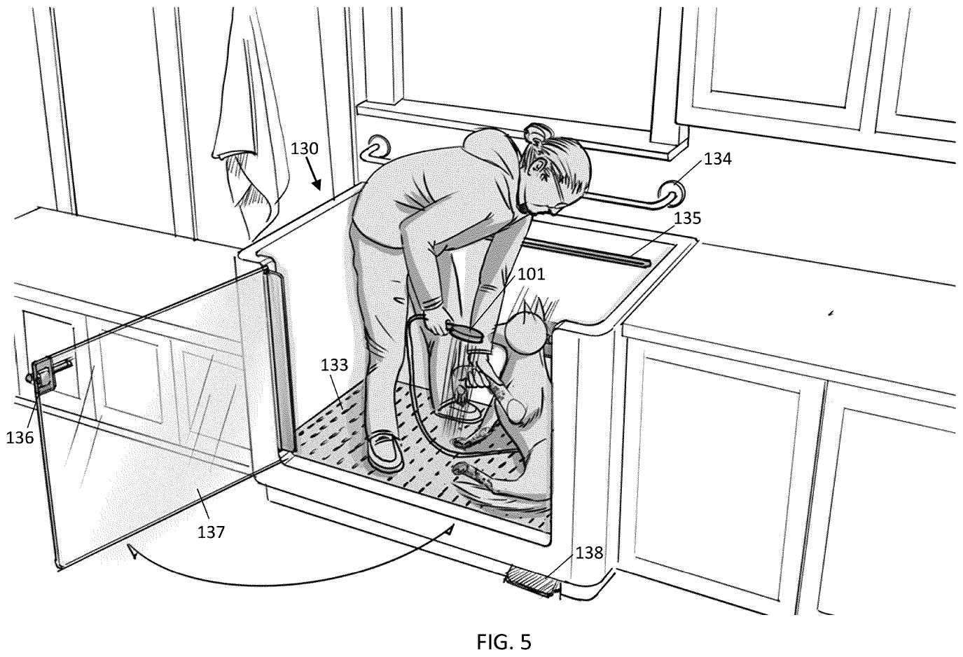

FIG. 5 illustrates another example pet washing station 130 with the adjustable grate 133 in the lowest position and the door 137 opened.

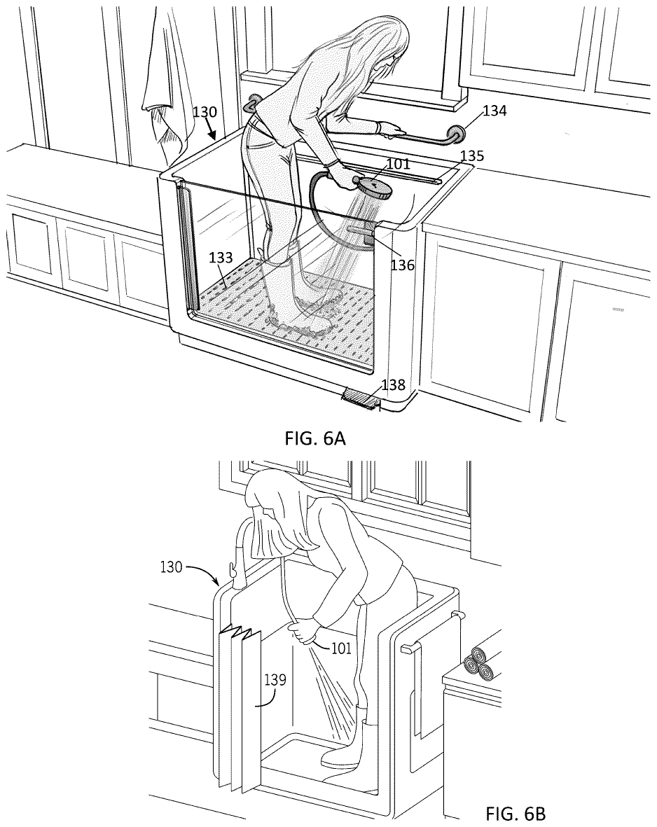

FIG. 6A illustrates another example pet washing station 130 with the door 137 closed used so that the user can easily wash boots or other items easily without splashing water. A grab bar 134 may allow the user to grip and maintain balance. The adjustable grate 133 may include a rubber non-slip mat that is perforated for draining. FIG. 6B illustrates another pet washing station 130 including an accordion style door 139. An accordion style door 139 may include multiple segments that slide along a track. The multiple segments fold into one another at acute angles.

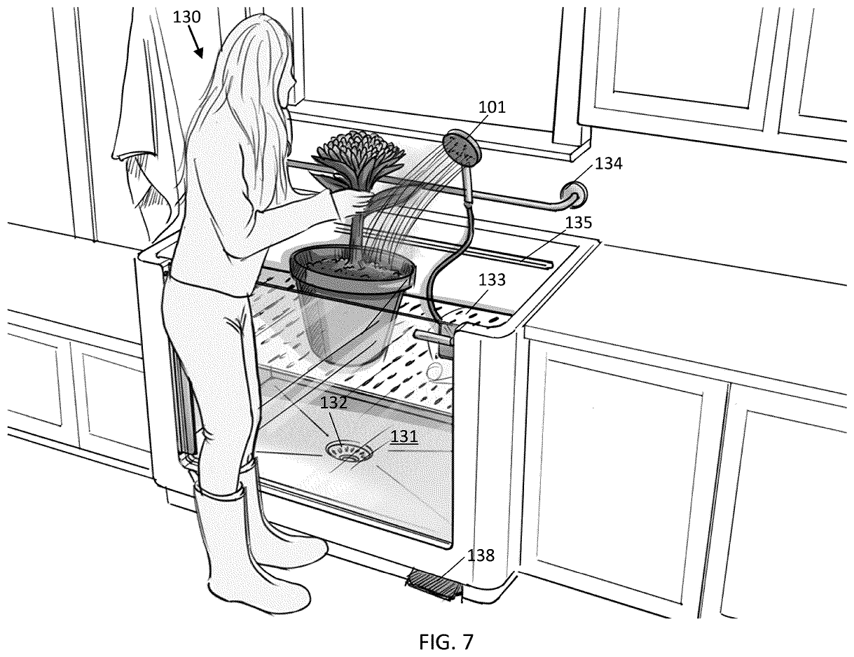

FIG. 7 illustrates another example pet washing station 130 with the adjustable grate 133 at a high position so that the user can water potted plants. Many of the embodiments of the pet washing station 130 may replace a traditional utility sink. The pet washing station 130 can be used for any utility sink functions such as washing hands, soaking clothes, emptying washing machine hoses, washing messy/large items, washing small dogs.

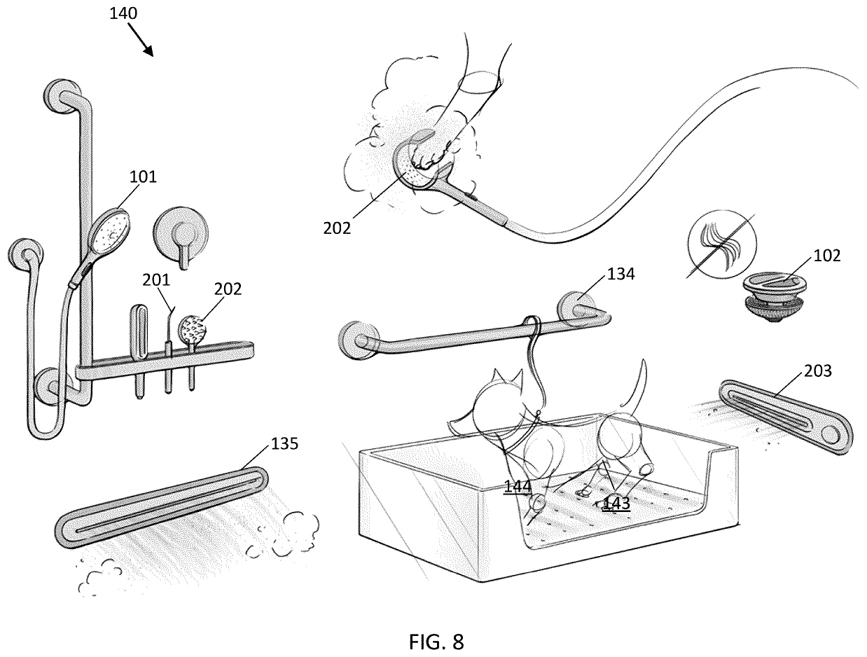

FIG. 8 illustrates an example pet washing kit 140. One or more of these items may be installed as part of the pet washing station 130 or separately to enhance pet washing in a shower, a sink, or other device. The pet washing kit 140 may include the handshower 101 along with various accessories such as a pick 201 or paw cleaner 202, a drain 132, a grab bar 134, a water sheet supply 135, and a dryer 203. The dryer 203 may be wall-mounted and configured to provide air flow into the pet washing station 130. The dryer 203 may include a duct connected to an air pump or air blower. The user input 138 or data entry device may provide instructions to activate the dryer 203. For example, the dryer 203 may be used after the handshower 101 (e.g., after washing) to dry the fur of the pet.

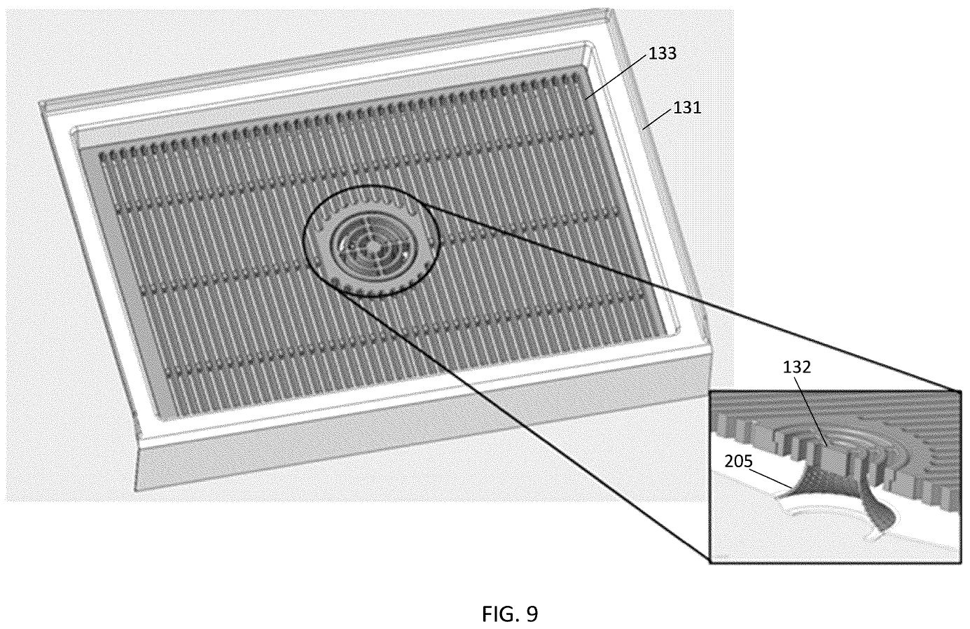

FIG. 9 illustrates an example grate and separation drain. The grate 133 may have two patterns of openings. A first pattern is applied to the area over the drain and a second pattern is applied to the remining area of the grate 133. The drain 132 may include a vertical catch 205 configured to catch fur in the drain and pass water past the drain.

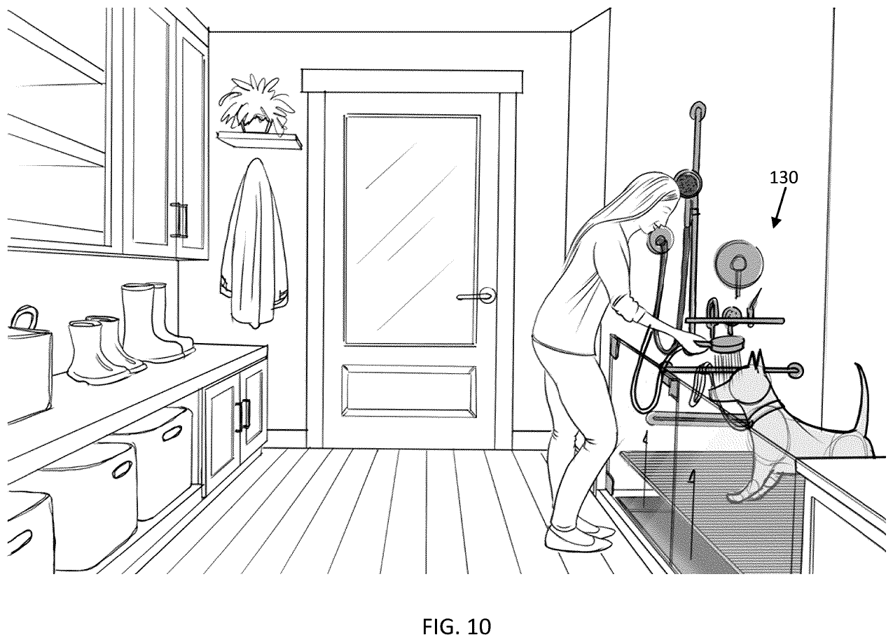

FIG. 10 illustrates another example pet washing station 130 construction for pet washing kit 140.

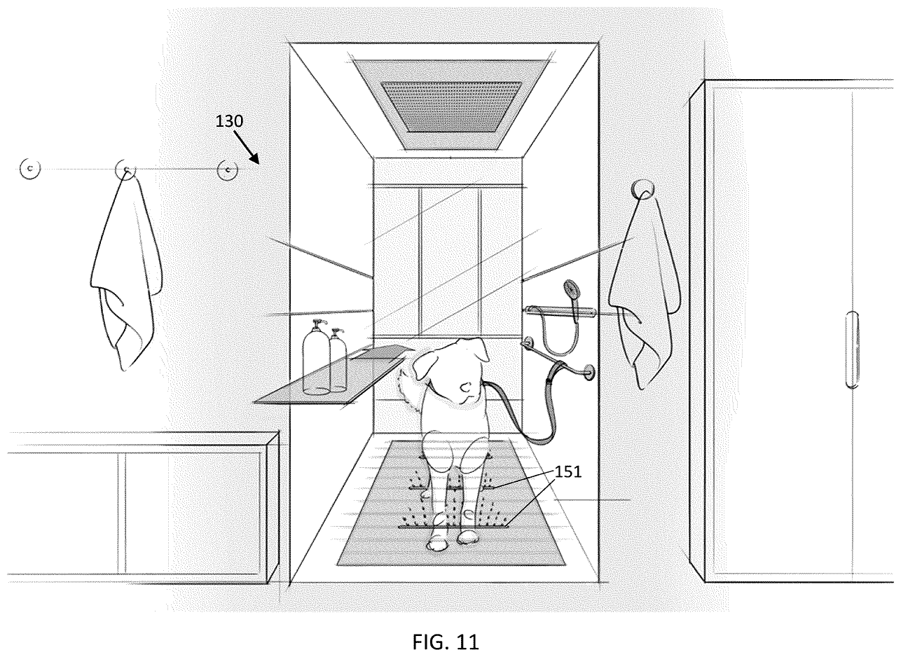

FIG. 11 illustrates another example pet washing station 130. The pet washing station 150 include floor sprayers 151 configured to spray the underside of the pet. The user input 138 or data entry device may provide instructions to activate the floor sprayer 151.

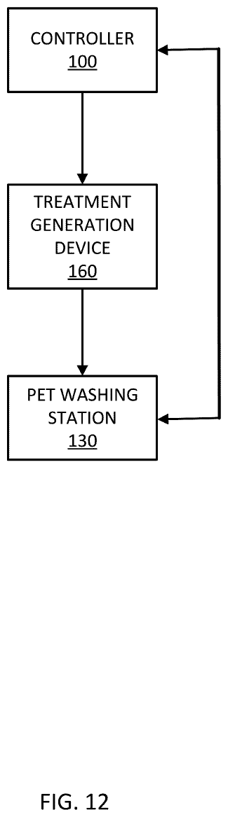

FIG. 12 illustrates a water treatment control system for the pet washing station 130. The water treatment control system may include a controller 100, which may be the same controller described herein with respect to the handshower 101, the adjustable grate 133, and/or other controllable components of the pet washing station 130, and a treatment generator 160. The treatment generation device 160 may apply one or more of the following water treatments to the water that is provided to the pet washing station 130. The treatment may be applied inline (e.g., along a pipe in the plumbing system for the water supply) or be applied to an intermediary tank (e.g., a container of water in the wall or otherwise connected to the water supply of the pet washing station 130. The intermediary tank may be incorporated into the handshower 101. The intermediary tank may be behind the wall of the bath fixture 131 or the wall of the room.

The treatment generation device 160 may generate microbubbles. The term microbubbles may be used to describe bubbles with diameters that are approximately from 1 to 100 μm. Additional bubbles may be present when microbubbles are generated such as bubbles with diameters from 100 to 1000 μm or larger. Microbubbles may have a lifetime duration before implosion in water. In one example, the lifetime duration may be at least 1 minute. In some examples, the lifetime duration is in the range of about 2 to 4 minutes. In one example, an air stream under pressure is dissolved into liquid with a nozzle to generate bubbles under the cavitation principle. The nozzle may be a venturi tube. In cavitation the static pressure of a liquid is below the liquid's vapor pressure, causing vapor filled cavities to form. The vapor pressure is the pressured in thermodynamic equilibrium with the other phases (liquid and solid) at a specific temperature. In another example, microbubbles are formed from ultrasound to induce cavitation in the liquid. In another example, microbubbles are formed through a shearing force. The air stream is provided under low pressure and bubbles are broken off into the liquid using the shearing force. The shearing force may be a vibration, provided from fluidic oscillation, or other methods.

Microbubbles may provide a variety of benefits in a variety of applications. Some benefits may be considered water treatments. Some benefits may improve the feel, texture, and appearance of the water. Water with microbubbles may feel silky to the touch and may increase moisture level when in contact with the human body such as skin and hear. In addition, microbubbles may enhance the surface cleaning, dirt removal, oil removal, and cosmetics removal abilities of the water. Water with microbubbles may aid in removal of scale buildup on surfaces.

In some examples, the microbubbles experience cavitation, resulting in an implosion of the bubbles to release hydroxyl radicals and causing physiochemical transformations in the water. In some examples, the microbubbles have an electrostatic charge on or associated with the surface of the bubble such that the presence of the bubble treats or otherwise affects the water before the microbubbles ultimately implode. The electrostatic charge on the microbubbles may be negative.

The generation device 160 may include at least one electrical input to a power source and at least one air input to an air source (e.g., a pump). The bubble generation device 160 may receive commands from the controller 100. The controller 100 may instruct the generation device 160 when to start generating bubbles (e.g., initiation command) and when to stop generating bubbles (e.g., stop command). The command from the controller 100 may include a size or a size range from the generation device 160. The generation device 160 may adjust a parameter of the bubble generation process. In one example, the parameter is a magnitude of the shearing force for bubble generation. In one example, the parameter is a flow of an air stream for generating microbubbles. In one example, the parameter may be a magnitude of a vibration or fluid oscillation.

The treatment generation device 160 may produce ozone. Ozone may be formed by the generation device 160 using a variety of techniques, including corona discharge, ultraviolet light, cold plasma, and other techniques. For example, a corona charger may be configured to accumulate electric charge from the power source and apply the electric charge to air from the air source.

The treatment generation device 160 may produce electrolyzed water. The treatment generation device may be configured to electrolyze water to generate hypochlorous acid using an electric charge and the residual salt in the water. The electrolysis process may produce HOCl, O₃, and/or H₂O₂. In some examples, additional salt (i.e., salt not residual in the water) may be added to the intermediary tank water. Other byproducts such as hydrogen gas may be vented from the intermediary tank. The treatment generation device 160 may comprise two plates (e.g., a cathode plate and an anode plate). Each plate may be formed of metal or a conductive material. Each plate may be electrically connected to a power source directly or through controller 100. The anode may be disposable. That is, the user may remove and reinstall the anode at a time interval or as needed. Vinegar or peracetic acid may be added to the water as a reactant.

The controller 100 may send commands to the treatment generator device 160 to provide current (e.g., increase current) to increase the concentration of hypochlorous acid in the water. The controller 100 may decrease current in order to decrease the concentration of hypochlorous acid in the water.

A feedback sensor may detect the pH level in the water (e.g., acidic property or basic property). For example, a predetermined pH (e.g., 5.5 or 6.0) may indicate strong cleaning ability of the solution. A neutral pH (e.g., 7.0) may indicate an equal concentration of hypochlorous acid and hypochlorite ion. The controller 100 may compare the pH to a threshold level. When the detected pH is greater than the threshold the current is increased to increase the amount of hypochlorous acid. When the detected pH is less than the threshold the current is decreased to decrease the amount of hypochlorous acid.

The controller 100 may send commands to the generation device 160. For example, the commands may initiate the generation of bubbles. The commands may be triggered by a time schedule (e.g., once every predetermined time period or at certain times of day). The commands may be triggered by operation of the pet washing station 130. That is, the controller 100 may send a command to the generation device 160 to generate bubbles when the handshower 101 is triggered. The handshower 101 may include an electronic sensor with trigger button 112 that connects to the controller 100 and initiates operation of the generation device 160.

The controller 100 may send a command to the generation device 160 to generate bubbles in response to a user input. For example, the user may provide an instruction via the user input 138. There may be a separate button for initiation of the generation device 160. The user may key in a predetermined entry on the data entry device to initiate operation of the generation device 160.

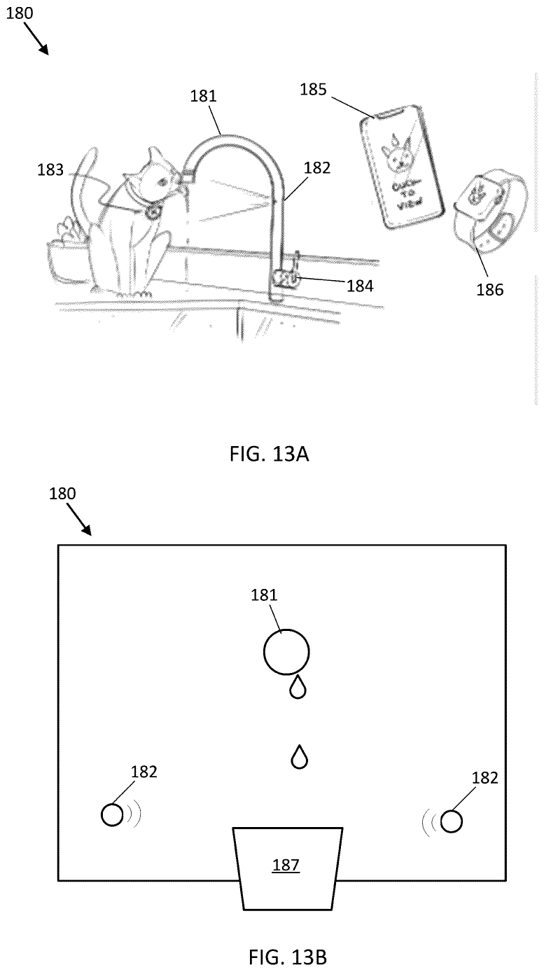

FIG. 13A illustrates a pet triggered faucet system 180 (automative faucet) that empowers animals to operate a faucet. The pet triggered faucet system 180 includes a water dispenser 181, a sensor 182, and a valve 184. One or more devices may communicate with the pet triggered faucet system 180 including a tag 183 (e.g., smart tag), a mobile device (e.g., smartphone 185), or a wearable device (e.g., watch 186). Additional, different or fewer components may be included.

FIG. 13B illustrates another example pet triggered water dispenser system 180. In this example, the water dispenser or pet triggered water dispenser system 180 may be outside, low to the ground, or a standalone device. A container 187 may be used to collect excess water. Multiple sensors 182 may be used and place on opposite sides of the water dispenser 181. Additional, different or fewer components may be included.

The pet triggered faucet system 180 is configured to identify a pet and operate the valve 184 in response to the identification. The pet triggered faucet system 180 may include a controller that operates the valve 184. For example, the controller may generate an instruction to operate a motor or energize a solenoid that opens or closes the valve by a predetermined amount.

The sensor 182 is configured to collect sensor data for the animal in proximity to the pet triggered faucet system 180. In some examples, the sensor data includes image data collected by an image sensor or camera. In other examples, the sensor data may be collected by motion sensors, proximity sensors or other sensors that describe the motion of the pet. In other examples, the sensor data may include identification information transmitted by or otherwise associated with a device worn by the pet.

The sensor 182 may include various types of sensors to identify the pet. In one example, the sensor 182 communication over short range wireless protocols with the tag 183. Example protocols include wireless communication include radio frequency identification (RFID) or near field communication (NFC).

The sensor 182 may include an image sensor or camera that collects image data representing the pet when the pet approaches or is proximate to the water dispenser 181.

The controller 100 is configured to identify the animal from the collected sensor data and activate the valve in response to the identified animal. When the sensor data is image data, the controller 100 is configured to compare an image of the animal to at least one template to identify a pet. For example, the pet triggered faucet system 180 may be programmed with a single template when configured by the user by uploading a photograph of the user's pet (or multiple photographs and various angles, distances, etc.). The user may configure the pet triggered faucet system 180 with multiple pets using multiple images. When the controller identifies a match between the collected sensor data and the stored template, the controller sends an instruction to the valve 184 to open water flow. The amount that the valve 184 is opened may be a predetermined amount set by the user (e.g., a drip, a small water flow). The controller may include a timer used to close the valve 184 after a predetermined time elapses after the valve 184 is opened.

In one embodiment, the controller 100 may identify a variety of pets based on multiple templates. In this example, different valve settings may correspond to different pets. For example, the controller may store a lookup table that associates a small pet with a low flow valve setting and a large pet with a high flow valve setting. The controller is configured to select a valve setting in response to the identified animal when different valve settings correspond to different animals.

The sensor data may describe the shape, size, and/or motion of the pet. The controller may store pet signatures based on the shape, size, and/or motion of the pet. The controller may compare the collected sensor data to the stored pet signatures to identify the pet according to the examples above.

The controller 100 may also track the amount of water that the pet is receiving. For example, the controller may record how often the valve 184 is activated. The controller may generate a message for the user and send the message to the mobile device or wearable device when the water access by the pet falls below a predetermined level. The message may be alternatively sent periodically and include data for the amount of water accessed by the pet.

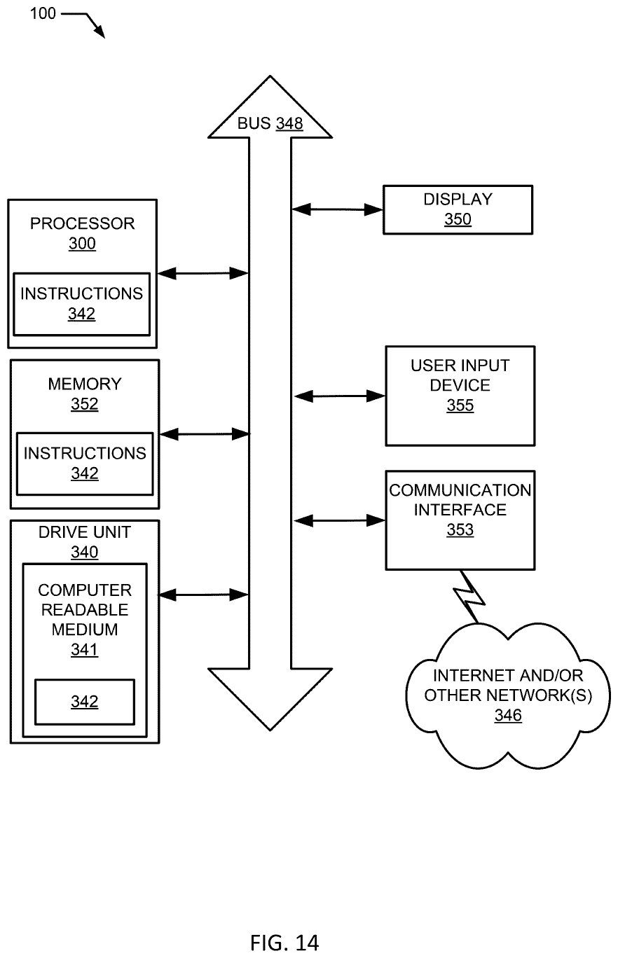

FIG. 14 illustrates a control system (e.g., controller 100) for any of the disclosed embodiments. The controller 100 may include a processor 300, a memory 352, and a communication interface 353 for interfacing with devices or to the internet and/or other networks 346. In addition to the communication interface 353, a sensor interface may be configured to receive data from the sensors described herein or data from any source for identification of animals. The components of the control system 100 may communicate using bus 348. The control system 100 may be connected to a workstation or another external device (e.g., control panel) and/or a database for receiving user inputs, system characteristics, and any of the values described herein.

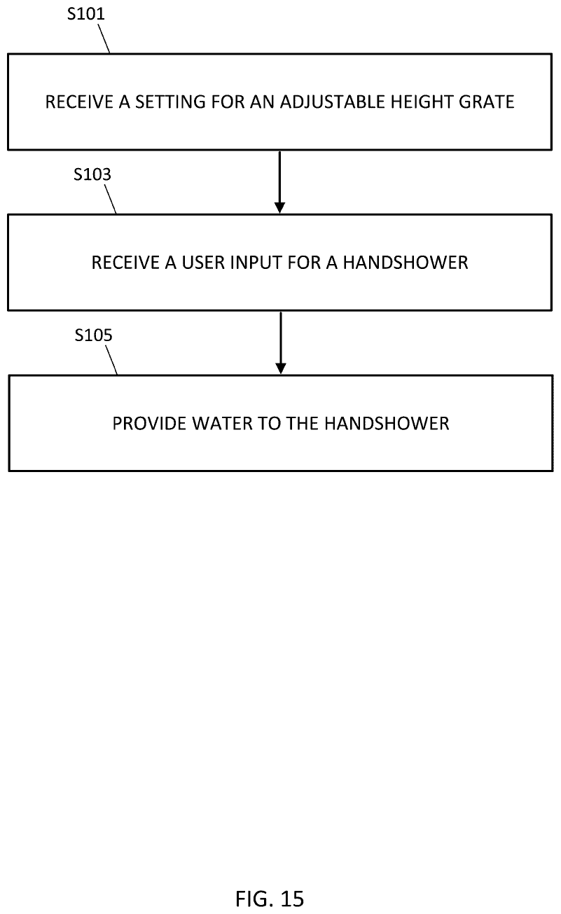

FIG. 15 illustrates an example flow chart for the controller of FIG. 14. Additional, different, or fewer acts may be included.

At act S101, a height for an adjustable grate is set by the user or automatically using a motor or solenoid. The processor 300 may receive an input from the user input device 355 that defines the height (e.g., a particular distance, or distance range). The processor 300 may generate a command for a powered device (e.g., motor, solenoid) to move the adjustable gate to the height. In one example, the powered device is coupled to the adjustable frate using a cable or gear drain.

At act S103, a user input for a handshower is received. The processor 300 may receive an input from the user input device 355 that defines a water flow for the handshower. The input may define a valve setting for the handshower. The processor 300 may generate a command for the valve of the handshower in response to the valve setting.

At act S105, water is provided to the handshower in response to the user input.

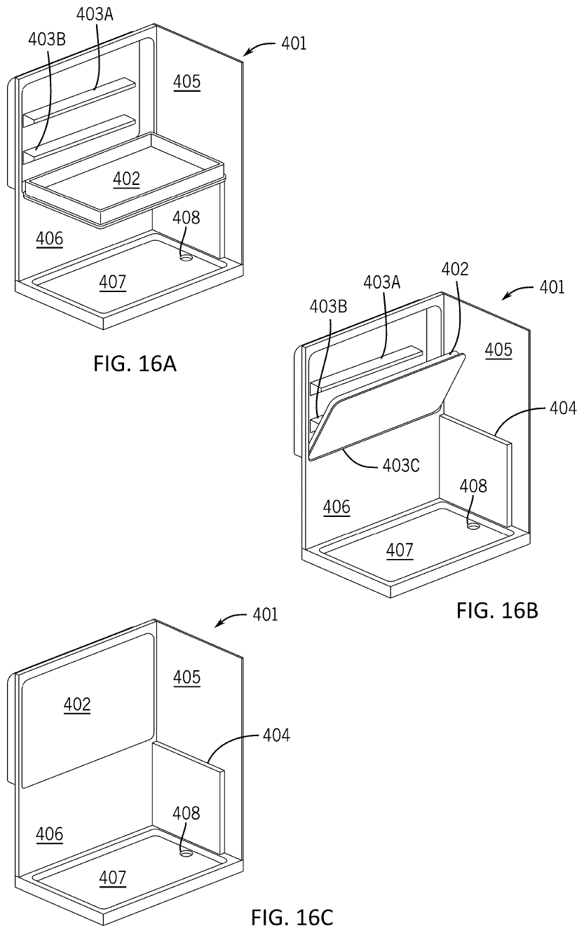

FIG. 16A-C illustrates a pet washing station 401 including a folding platform 402, a back wall 406, one or more sidewalls 405, and a base 407. The base 407 includes a drain 408 through which water exits the pet washing station 401. The drain 408 may be connected to a P-trap in the base 407. Additional, different or fewer components may be included.

The folding platform 402 is configured to be operable in a washing position, as shown in FIG. 16A, where the folding platform 402 is substantially horizontal or flat. The folding platform 402 may rest on a ledge 404 that extends out from the one or more sidewalls 405. There may be a ledge 404 on each side of the folding platform 402 and the folding platform 402 may rest on both ledges 404 in the washing position. The ledges 404 support the folding platform 402 and an animal placed on the folding platform 402 for washing. The folding platform 402 may be moved by pivoting the folding platform 402 with respect to the back wall 406, as shown in FIG. 16B. Finally, the folding platform 402 is placed in a stowed position, as shown in FIG. 16C wherein the folding platform 402 is substantially vertical and may be pressed against the back wall 406. The folding platform 402 may be moved from the stowed position to the washing position by gripping and pulling or pivoting the folding platform 402.

Several pivoting ledges 403A-C extend from the back wall 406. As shown, the movable platform 402 rests on pivoting ledge 403C to pivot between the washing position and the stowed position. Higher positions for the movable platform 402 may be achieved by resting the movable platform on either of pivoting ledges 403A and 403B. In addition, the pivoting ledges may provide a mechanism to hold the movable platform 402 in the stowed position. For example, when the movable platform 402 pivots and rests on pivoting ledge 403C, the movable platform 402 may snap into friction fit with the pivoting ledges 403A and 403B. That is, the pivoting ledges 403A and 403B may have a length and/or other dimensions that fits within the cavity of the movable platform 402 in order to hold the movable platform 402 in the stowed position. The pivoting ledges 403A and 403B may secure the movable platform 402 through a friction fit or another mechanism. The folding platform 402 be supported by a first ledge 403C of the at least one side wall at a first height, a second ledge 403B of the at least one side wall at a second height, or a third ledge 403A of the at least one side wall at a third height. The platform 402 is movable between the first ledge 403C, the second ledge 403B, and the third ledge 403A.

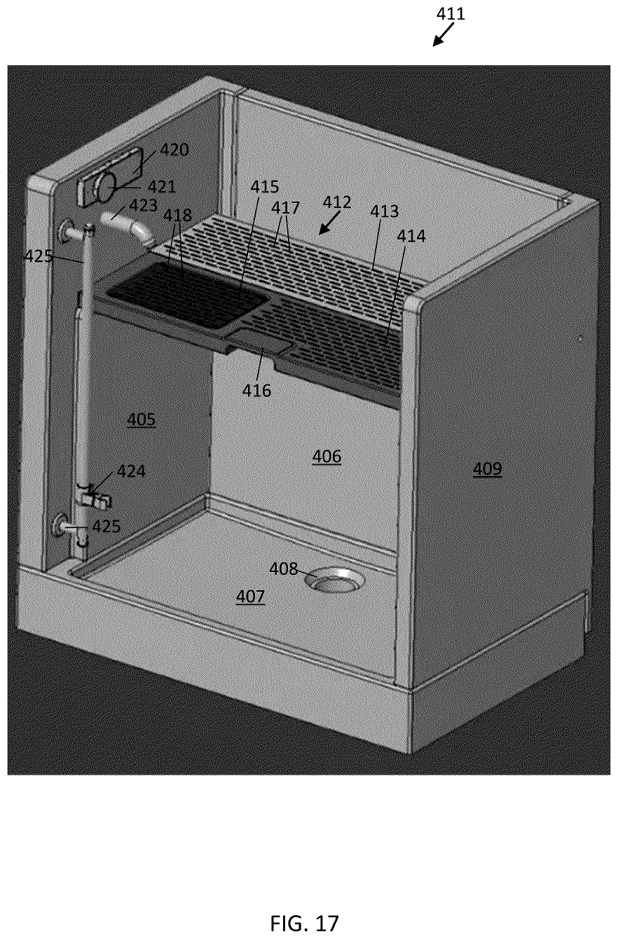

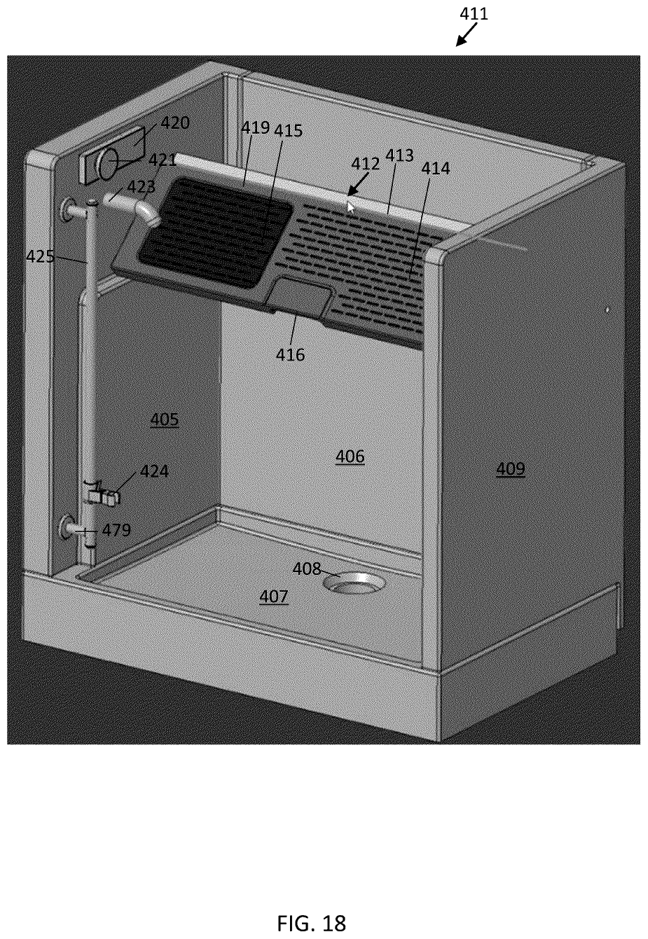

FIGS. 17 and 18 illustrates an example pet washing station 401 with a versatile washing platform 412. The versatile washing platform 412 may include a front plank 414 and a rear plank 413. The front plank 414 and the rear plank 413 may be joined by a hinge 419 so that the front plank 414 and rear plank 413 fold to an acute angle and the versatile washing platform 412 may be folded away to the side. In other example, the front plank 414 may fold down, leaving the rear plank 412 as a small platform. A handle 416 may be gripped by the user to rotate the front plank 414 and the rear plank 413 with respect to each other and/or to fold down the front plank 414.

The at least one side wall 405 may be coupled to one or more water supply devices. For example, a faucet (or spigot) 423 may extend from the side wall 405. A handshower and a hose as described in other examples herein may be coupled to the faucet 423. A bar 425 may also be connected to the side wall 405. The bar 425 may be supported by one or more support arms 479 that are coupled to the side wall 405. The bar 425 may include one or more connectors 424 for holding the handshower. In addition or in the alternative the bar 425 may include one or more sprayers for spraying the interior of the pet washing station 401 including the versatile washing platform 412.

Water from the water supply (e.g., used for washing the pet on the versatile washing platform 412) falls through one or more openings 417 in the platform 412 toward the at least one drain opening 408. Both the front plank 414 and the rear flank 413 includes openings 417. The openings 417 may be sized small enough so that pad of dogs and cats cannot be caught within the openings 417.

A removable basin 415 may be supported by the versatile washing platform 412. The removable basin 415 may fit within a hole in the versatile washing platform 412 and a rim or lip of the removable basin 415 may rest on the edge around the hole in the versatile washing platform 415. Other securing mechanism may be used.

The removable basin 415 may be configured to hold water (i.e., the basin 415 does not include openings). The basin 415 may be used to for sponges or cloths to be rinsed and provided with soap. The pet may be partially submerged in the basin 415. The basin 415 may be collapsible. That is, the side walls of the basin 415 may have pleats or folds that allows the basin 415 to be extended to an open position having a first depth or collapsed to a closed position have a second depth, or no depth such that the basin 415 is planar.

Various embodiments include a controller and user input, which may be implemented by a control panel 420 and dial 421. As shown in FIGS. 17 and 18, the dial may set a temperature for the water which adjusts a valve in the sided wall to mix the hot and cold supply to provide water from faucet 423 (e.g., to the handshower 101). A thermostat may be used to mix the water to a temperate set by the dial 421. The control panel 420 may turn the water supply ON and OFF.

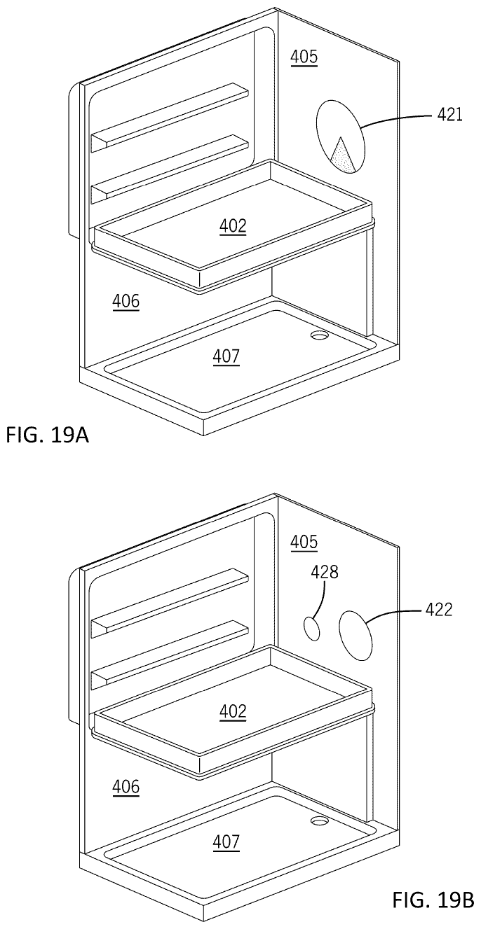

FIG. 19A illustrates another example pet washing station with a grooming device 421. The grooming device 421 may include an opening in the side wall 405 with a nail grinder. The pet, either directly or through assistance by the user, may place a paw include nails into the grooming device 421 where the nail grinder shapes or trims the nail. The grinded material may fall to a compartment or be rinsed away with water. For example, the grooming device 421 may have an exhaust passage that connects to the drain 408. In this way, water may be sprayed into the grooming device 421 to cause the waste from the grooming device 421 to travel through the drain 408.

FIG. 19B illustrates another example pet washing station with a food dispenser 422 on the side wall 405. The food dispenser 422 may include a lever or button 428 that can be actuated by the user to dispense a treat or other food from the food dispenser 422. In some examples, the pet may place a paw or nose in position to depress the button 428 to dispense food.

The food dispenser 422 may also be tied to the washing system such as handshower 101. When the handshower 101 is turned off, food may be dispensed. Alternatively, when the handshower 101 has been operated for a predetermined amount of time or dispensed a predetermined amount of water, food may be dispensed. In this way, the food dispenser 422 is actuated as a treat after bathing is complete.

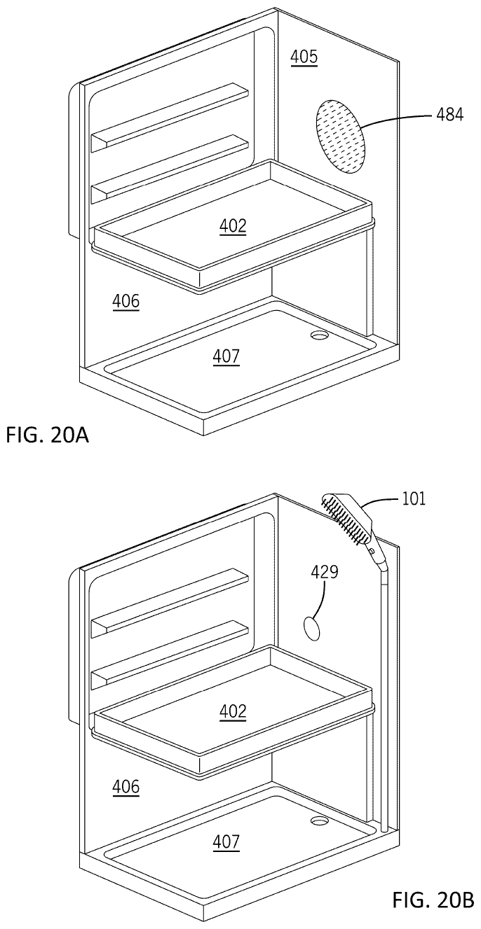

FIG. 20A illustrates another example pet washing station with a window 484. The window includes an opening in the side wall 405. The opening may be covered with plastic, glass, or other translucent or transparent material. The window 484 allows the pet to look outside the pet washing station 401 during bathing.

FIG. 20B illustrates another example pet washing station with a pet operated washing device such as mounted handshower 101. A button 429 is mounted on or otherwise coupled to the side wall 405. The button 429 may be within the reach of the pet when standing or sitting on the platform 402. The pet may press the button 429 to turn on the water sprayer. The button 429 may open a valve for the water sprayer or provide an electric signal to a solenoid for opening a valve for the water sprayer. In addition or alternative, a motion sensor may be used. The motion sensor may include a camera or other image sensor that collects images of the pet. The handshower 101 may be activated when a controller analyzes the images to determine that a pet is present on the platform 402.

In addition or the alternative, a soap dispenser may be mounted on the side wall 405. The soap dispenser may dispense soap onto the pet that is sitting or standing on the platform. The soap dispenser may dispense soap in response to actuation of the button 429. The soap dispenser may be activated when a controller analyzes the images to determine that a pet is present on the platform 402.

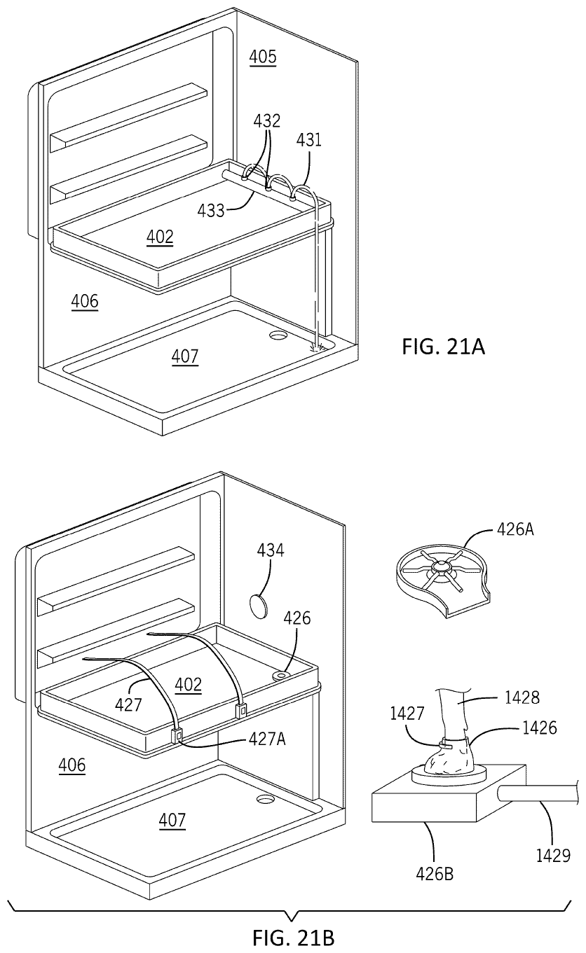

FIG. 21A illustrates another example pet washing station 401 with a fountain. The fountain may include one or more jets 432 that are connected to the water supply and may include a small pool of water in compartment 433. The jets 432 may propel water in success in a predetermined timing and pattern so as to simulate the stream of water jumping across the pool of water, as shown by pattern 431. A controller may generate instructions to fire the jets 432 in the predetermined timing. Water from the last jet 432 may fall to the base 407 and eventually the drain 408. The water in the pattern 431 may be positioned so that a pet or the platform 402 can drink from the water. The pet may also be stimulated by the pattern 431 and chase or paw at the pattern 431.

In another example, a water inflated toy may be placed on the jets 432. The toy may take the shape of a mouse or other object. As water flows through the water inflated toy, it bounces in multiple directions and stimulates the pet.

FIG. 21B illustrates another example pet washing station with a pet operated paw washing device 426. The paw washing device 426A may dispense water when pressed down. Thus, a pet may push down with a paw, or otherwise stand on the paw washing device 426A, to cause water to be dispensed to wash the inserted paw. In addition, a user input 434 (e.g., button, lever, etc.) may be used to turn on the paw washing device 426A.

As shown in FIG. 21B, and applicable to all embodiments, a safety harness 427 may be used to secure the pet on the platform 402. The harness 427 may include one or more straps secured to the side wall 406 and or the platform 402 with buckles, Velcro, snaps, or other securing mechanism 427A. After the pet is placed on the platform 402, the safety harness 427 is secured to hold the pet safely on the platform 402.

Another paw washing device 426B is illustrated where the leg 1428 and paw of the pet is placed in a chamber 1426. A buckle 1427 like a ski boot is used to clamp down on the leg 1428 to create a sealed chamber. An elastic fabric may be in contact with the leg of the pet for comfort. Water 1429 through a tube is provided to the paw washing device 426B and water sprays up from the bottom to wash the paw.

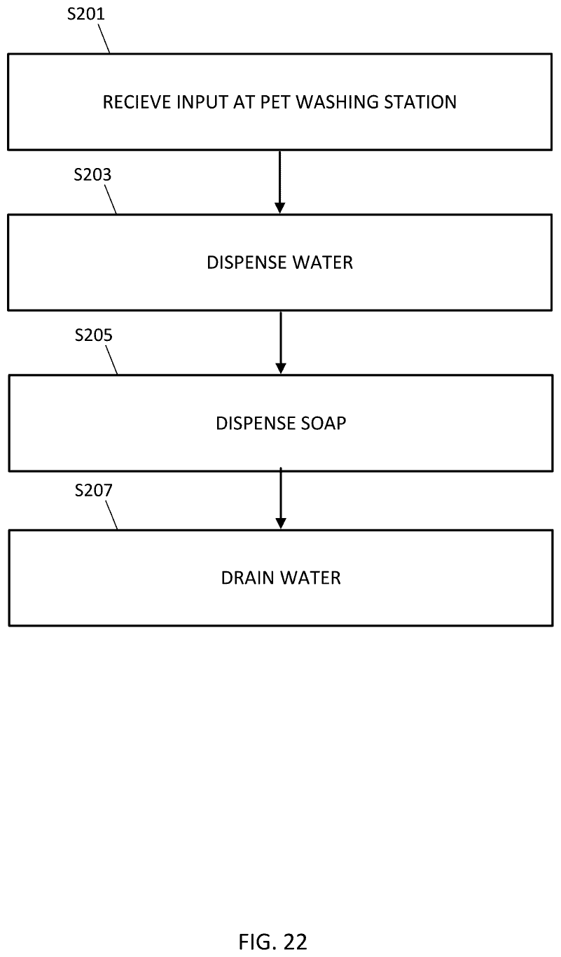

FIG. 22 illustrates an example flow chart for the pet washing station. Additional, different or fewer components may be included.

At act S201, an input is received at a pet washing station. The input may be received as input device 355. The input may specify a wash cycle.

At act S203, water is dispensed in response to the received input. The controller 100 (e.g., processor 300) may send a command to open a valve to dispense the water.

At act S205, soap is dispensed. The controller 100 (e.g., processor 300) may send a command to open a valve to dispense the soap from a soap container.

At act S207, water is drained from the pet washing station. The water may be automatically drained through an open drain path. In another example, as part of the wash cycle, the controller 100 (e.g., processor 300) may send a command to open a drain valve to drain the water.

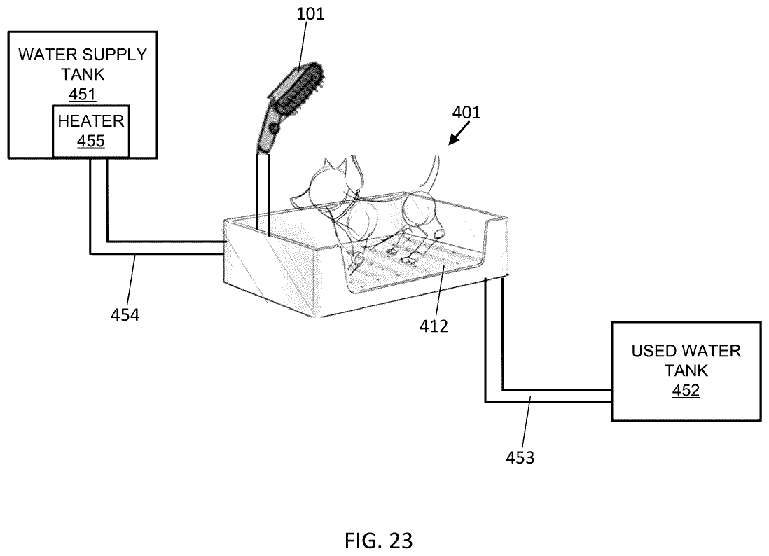

FIG. 23 illustrates a pet washing station 401 with an independent water supply. The term “independent” may mean not directly connected to a line supply (e.g., water main) at all times. The example of FIG. 21 includes a water supply tank 451 connected to the pet washing station 401 by a supply pipe 454 and a used water tank 452 connected to the pet washing station 401 by a drain pipe 483. Additional, different or fewer components may be included.

The pet washing station 401 includes a platform configured to support the pet. The water supply tank 451 is connected to handshower 101 or other water sprayer used to provide water for washing the pet on the pet washing station 401. The pet washing station 401 may include a foldable platform or movable platform as described in other embodiments herein.

Inside the base of the pet washing station 401 is one or more opening or channels that direct the water into the drain pipe 483. The base of the pet washing station 401 may have an angle that directs water to the drain pipe 483 under the force of gravity. In any of these scenarios, water from the water dispenser 101 passes through the platform to a drain and eventually through the drain pipe 483 to the used water tank 452 coupled to the drain and configured to store the water that has passed through the platform to the drain.

In some examples, the water supply tank 451 may include a heater 455. The heater 455 may be activated automatically when the water dispenser 101 is turned on. The water supply tank 451 may include a thermostat that signal turning on and off the heater 455.

In some examples, water from the main supply is mixed with heated water. The heated water may come from a bucket or other tank of water that has been heated to ambient temperature over time. A venturi passage connected to the heated water may draw the heated water in for mixture with the water supply tank 451.

In some examples, the water supply tank 451 is not an independent tank and instead connected to the main water supply. In this instance, the heater 455 may heat cold water provided to the water supply tank 451 while the heater 455 is heating water in the water supply tank 451. In other examples, the heater 455 is omitted, and the water supply tank 451 may be connected to both a cold water supply and a hot water supply (e.g., from a water heater). The water supply tank 451 or another portion of the pet washing station 401 may include a mixer valve configured to control a mixture of the water from the hot water supply and the cold water supply.

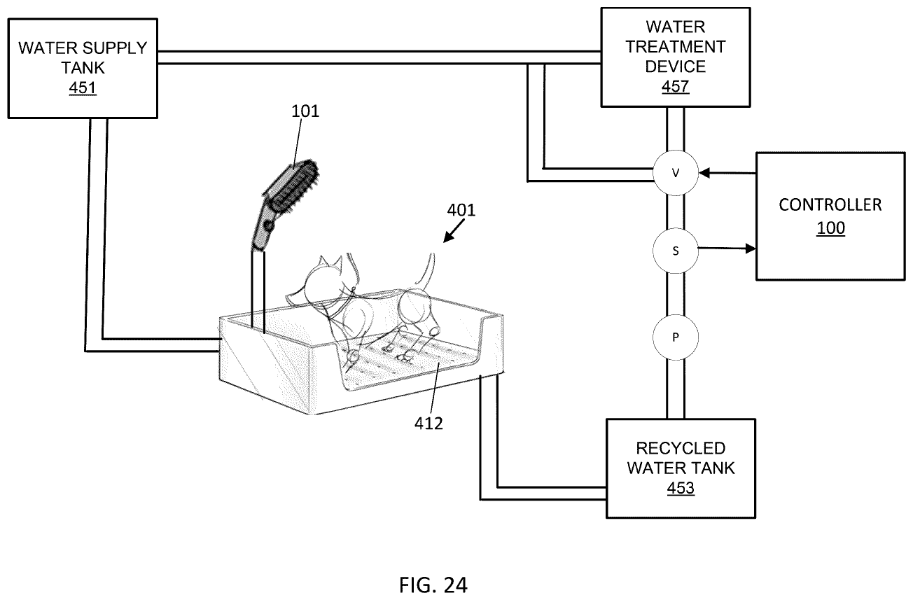

FIG. 24 illustrates a pet washing station with a recirculating water supply. In this embodiment, water collected in the recycled water tank 453 from the drain of the pet washing station 401 is provided back to the water supply tank 451. The recirculating water supply may include a pump P to provide water pressure or other force to pump the water from the recycled water tank 453 to the water supply tank 451.

The recirculating water supply may also include a water treatment device 457 configured to filter or otherwise remove one or more impurities from the water that has passed through the platform to the drain. The recycled water tank 453 is an example used water tank and is upstream of the water treatment device 457.

The water treatment device 457 may include ultraviolet radiation. The water treatment device 457 may include ozone generation. The water treatment device 457 may include filters, settling tanks, or centrifugal separation. Filters, settling tanks, and centrifugal separators may be used to separate particles from the bulk liquid. Sometimes coagulants are added to the fluid. These coagulants cause particle agglomeration creating larger particles for easier separation. Filter systems can require high pressure pumps depending upon the desired filter size. Both filters and settling tanks may require occasional maintenance to remove the collected material and/or replace the filter.

In addition, a feedback loop system for one or more water treatment devices 457 may include a sensor S configured to test one or more properties of the water in the water drained from the pet washing station 401 and/or in the recycled water tank 453. The controller 100 is configured to activate or deactivate the water treatment device in response to the sensor data. Data from a sensor is evaluated to determine whether a corresponding water treatment device should be bypassed. A water treatment device is bypassed when a valve V is opened to connect a path or pipe that circumvents the water treatment device 457.

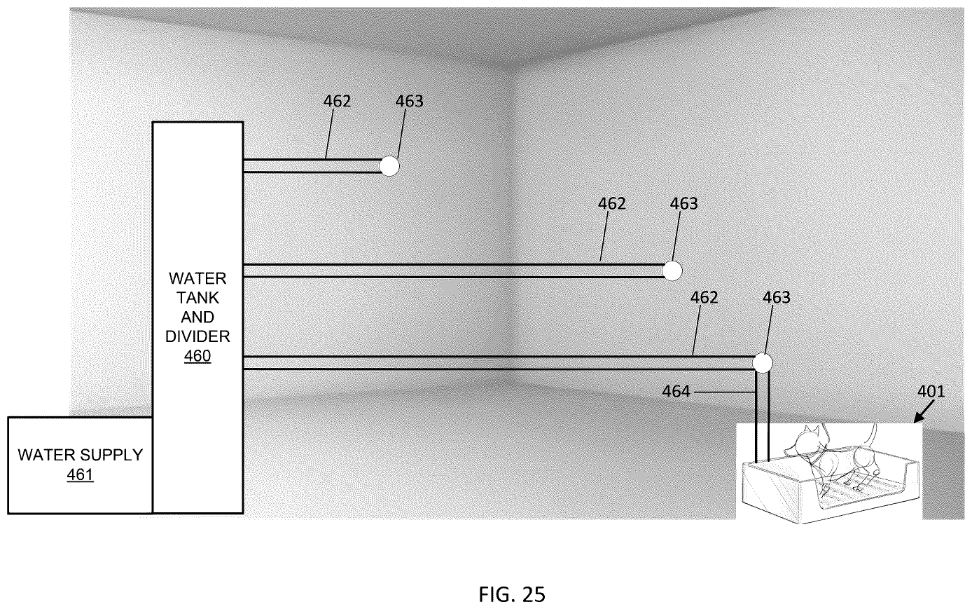

FIG. 25 illustrates an in-wall water distribution system for a house or another type of building. The in-wall water distribution system includes pipes that run through the walls of the building and provide outlets for water. In this way, a water consuming appliance (washing machine, dishwasher, sink, shower, bathtub, or others) can be quickly plugged into the system and receive water.

The in-wall water distribution system includes a main water supply 461, water tank and divider 460 (divider device), and multiple ports 463 connected by pipes 462. Additional, different or fewer components may be included.

The ports 463 are fixed to the wall or another structural component of the building configured to receive water from the divider device through the pipes 462. The divider device is configured to receive water from the main water supply and distribute the water to the ports 463. The divider device may include a network of valves to separate the flow of water from the main water supply to the multiple pipes 462.

The ports 463 each include a selectively open valve. The water appliances connect to the ports and open the valve. For example, the water appliance may have a hose 464 with a plug on the end of the hose 464. The plug connects with the port 463 to push over the valve. For example, the plug may be configured to be pressed within the port 463 to mechanically open the selectively open valve. The plug may be a quick connector that push open the valve and attached to the port 463 in a single motion. The plug may include a key to open the selectively open valve.

In some examples, two plugs are used or the plug has two channels for hot water and cold water. The plug may include a first mating connector for hot water and a second mating connector for cold water.

In some examples, the port 463 may include a pressure regulator configured to set a water pressure for the port 463. Different water appliances may use different water pressures. A user input such as a switch or dial at the port 463 may be configured to set the water pressure for the pressure regulator.

In some examples, an additional plug is used for the spent water. The additional plug may be a second plug or a third plug when separate hot and cold likes are used. The additional plug (return plug) is connected to the water appliance and configured to return used water. In this example, the port 463 may also be connected to a recycled water tank or a drain to a sanitary system. The recycled water tank may be downstream of a water treatment device.

The water appliance may be a pet washing station 401 according to any of the examples herein.

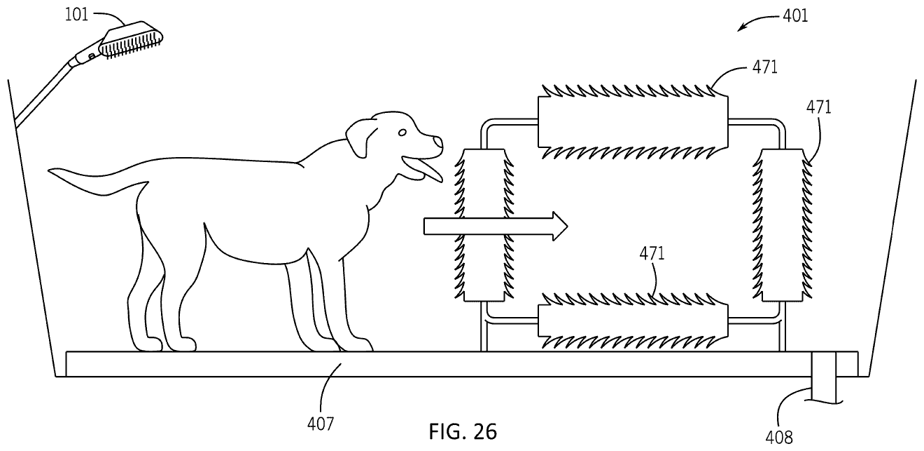

FIG. 26 illustrates a walkthrough pet washing station 401. The pet washing station 401 includes an arrangement of rollers 471 that form a pathway for the pet, as shown by the arrow. Multiple layers of rollers may be used. The rollers may be attached to a water supply such that water is dispensed from the rollers 471. In some examples, soap is also dispensed from the rollers 471. Separate sprayers (e.g., handshower 101) may also be included.

The pet steps through the pet washing station 401 from an entrance providing a path for a pet to enter the pet washing station 401 to an exit providing a path for the pet to leave the pet washing station 401. The sprayers provide water between the entrance and the exit. The rollers 471 are configured to apply soap to the pet between the entrance and the exit.

The pet washing station 401 includes a platform 407 between the exit and the entrance. A drain passage 408 is configured to collect water from the platform and provide the water toe a water recycling system or to a sewer/septic system.

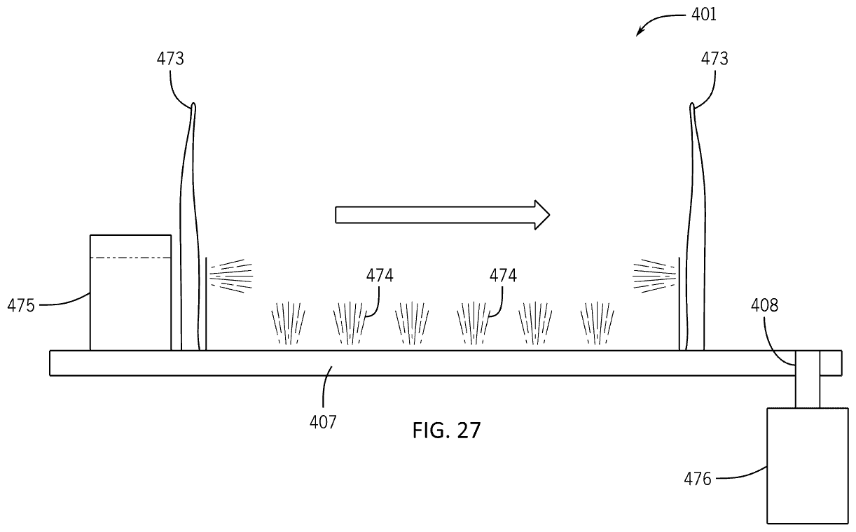

FIG. 27 illustrates a walkthrough pet washing station 401 with paw sprayers. In this example, one or more curtains 473 extend across the entrance and/or exit of the pet washing station 401. The curtains 473 may extend manually. The user may grip and stretch the curtains 473 across the entrance and/or exit. The curtains 473 may include a mechanical drive system (e.g., motor, solenoid) that push the curtains 473 open and pull the curtains 473 closed. The mechanical drive system may be electrically powered by a battery. The mechanical drive system may be controller by the controller 100.

One or more sprayers 474 may be positioned to spray the pet from the base of the pet washing station 401. The sprayers 474 may be short distances to clean the paws of the pet. The water for the sprayers may be pumped from an internal water supply connected to a tank 475. The water may be collected in a base 407 of the pet washing station 401 to a drain 408, which is connected to a used water tank 476.

In another example, the pet washing station 401 with curtains 473 may be coupled to an external water supply connected to a plumbing system.

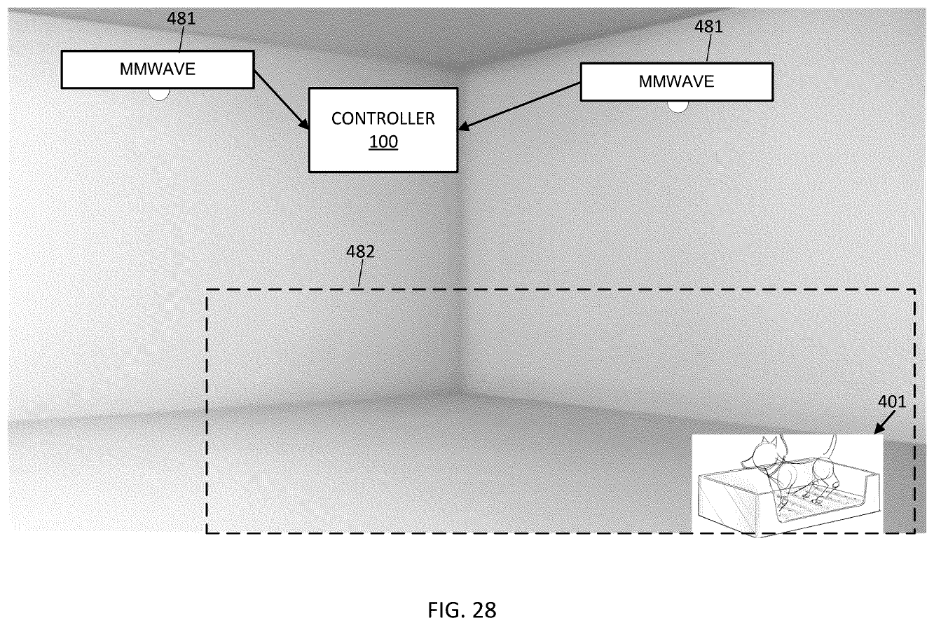

FIG. 28 illustrates a pet tracking system. One or more sensors 481 may be placed in a room or other space. A pet safe area 482 may be defined. The sensors 481 may be microwave radar sensors (e.g., mm wave sensor) configured to detect the presence of one or more objects or motion of one or more objects. The microwave radar sensor may be included in a control device according to the following embodiments, which includes a millimeter wave sensor module, a microcontroller unit (MCU), a solenoid valve or other type of valve, and at least one power supply or power supply circuit. However, for illustration controller 100 receives data from the sensor 481, and the controller 100 determines the location of the pet. The location may be within the pet washing station 401 or outside of the pet washing station 401. The location may be within the pet safe area 482 or outside of the pet safe area 482. The controller 100 may generate and send a message (e.g., to a user device) or an indication (e.g., illuminate an indicator or annunciate a speaker) that indicates the location of the pet.

The basic process of microwave ranging, and speed measurement is summarized according to the following. The transmission antenna (Tx chirp) of the millimeter wave sensor module transmits millimeter wave signal. The receiving antenna of the millimeter wave sensor module receives reflected waves (Rx chirp) when there is a user in the range. The emitted wave and reflected wave are mixed in the mixer to generate an intermediate frequency signal in the millimeter wave sensor. The MCU of the millimeter wave sensor performs fast Fourier transform (FFT) operation on the intermediate frequency signal to obtain the distance, intensity, and velocity information of the targets (e.g., users and urine steams). Based on the characteristics of radar signals, when a person approaches or leaves or when urination starts and ends may be identified.

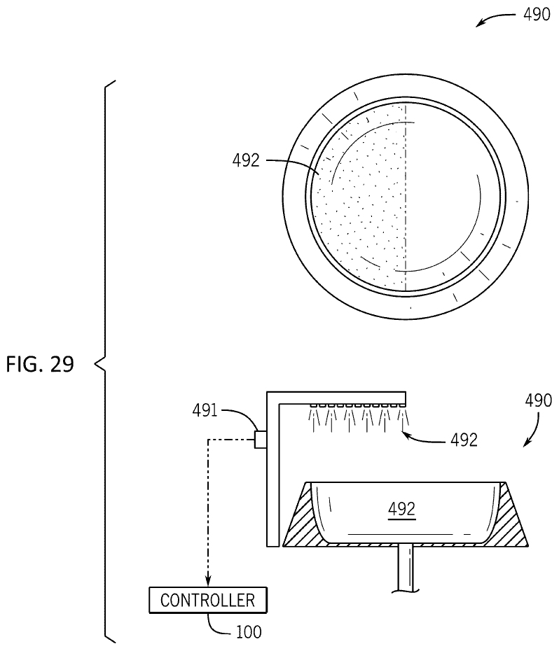

FIG. 29 illustrates a pet dish tracking and monitoring system. A pet dish 490 includes a cavity 493 configured to hold water or food, a sensor 491, and a treatment device 492. The sensor 491 may be located at least partially below a plane including a rim of the pet bowl. The sensor 491 may penetrate the pet dish 490. Additional, different or fewer components may be included.

The sensor 491 is a mm wave sensor that is configured to detect the contents of the bowl 490. The controller 100 may generate and send a message (e.g., to a user device) or an indication (e.g., illuminate an indicator or annunciate a speaker) that indicates when the bowl 493 is empty or nearly empty.

The sensor 491 is a mm wave sensor that is configured to detect contaminants in the bowl 490. The controller 100 may generate and send a command to the treatment device 492 to treat the bowl 490 when contaminants are detected. The treatment device 492 may include an ultraviolet light.

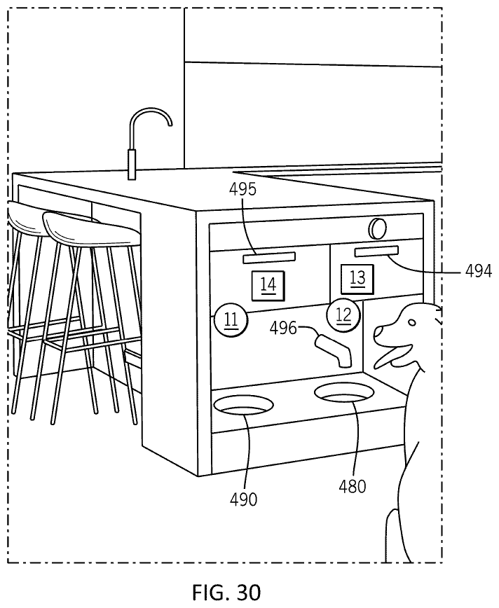

FIG. 30 illustrates a food and water dispensing system including a first bowl 490 (food dish), a second bowl 480 (water dish), a first treatment device 11, a second treatment device 12, a sensor 14, treatment device 13, a first drawer/compartment 495, and a second drawer/compartment 494. Additional, different or fewer components may be included.

A housing may support the first bowl 490 and in a predetermined position with respect to the housing and support the second bowl 480 in a predetermined position with respect to the housing.

The water dispenser 496 is configured to provide water from a main water supply to the second bowl 480. The treatment device 12 is configured to sanitize the second bowl 480 in the position with respect to the housing. Thus the second bowl 480 can be refilled with water and sanitized without being moved.

The treatment device 13 is configured to filter or treat the water for the water dispenser 496. The treatment device 13 may include an ultraviolet light. The treatment device 13 may include an ultrasonic emitter.

The controller 100 may analyze the data from the sensor 14 to determine whether the first bowl 490 and/or the second bowl 480 is empty or nearly empty. When the first bowl 490 is empty the controller 100 may generate a user message to add food. Alternatively, the controller 100 may activate an automatic food dispenser. When the second bowl 490 is empty, the controller may open a valve connected to the water dispenser 496.

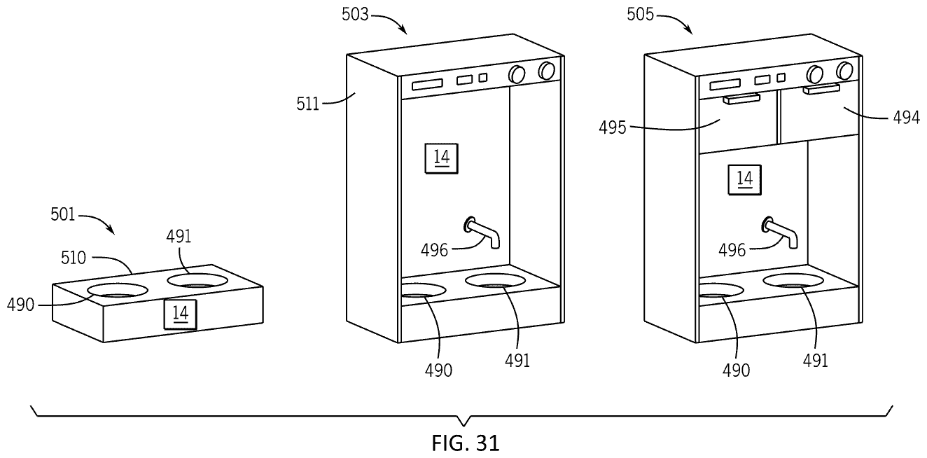

FIG. 31 illustrates modular configurations of the food and water dispensing system. In a first configuration 501, a pedestal 510 including the first bowl 490 and the second bowl 480. The sensor 14 may be mounted within the pedestal 510. A second configuration 501 also includes cabinet 511 and the water dispenser 496. The sensor 14 may be mounted within the cabinet 511. A third configuration 505 also includes the drawers 494 and 495. The sensor 14 may be mounted within or behind one of the drawers 494 and 495.

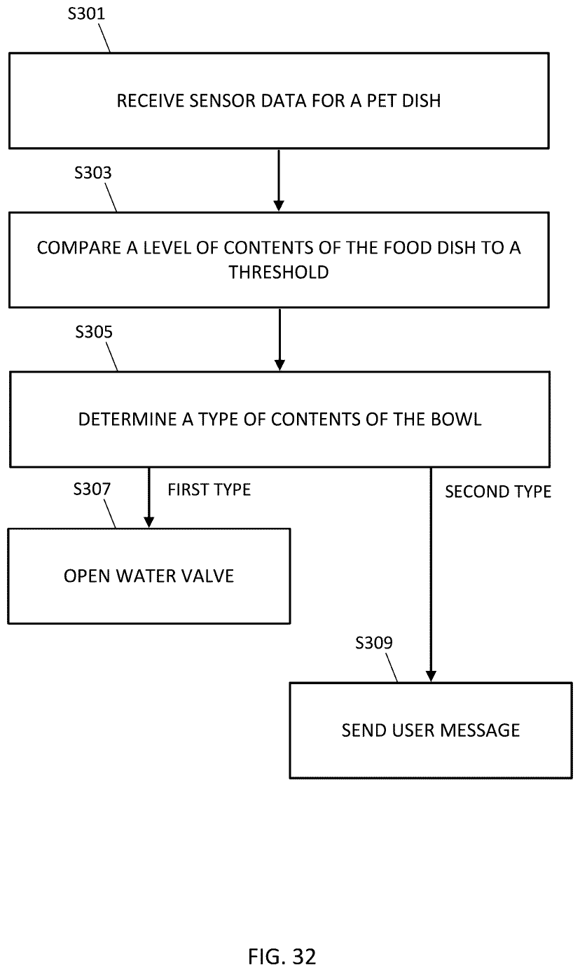

FIG. 32 illustrates an example flow chart for monitoring. Additional, different or fewer components may be included.

At act S301, sensor data for the pet dish is received. The sensor 14 may be a proximity sensor that detects a fill level of the pet dish.

At act S303, the controller 100 determines a level of contents of the pet dish. The controller 100 compares the level of contents to a threshold level. The threshold level may be set by the user.

At act S305, the controller 100 determines the type of dish. The type of dish may be determined based on the remaining material in the pet dish. The type of dish may be determined based on the position of the pet dish. At act S307, when a first type of pet dish is determined, a water valve is opened. At act S309, when a second type of pet dish is determined, a user message is generated.

Optionally, the control system 100 may include an input device 355 and/or a sensing circuit in communication with any of the sensors. The sensing circuit receives sensor measurements from as described above. The input device 355 may include a switch (e.g., actuator), a touchscreen coupled to or integrated with, a keyboard, a remote, a microphone for voice inputs, a camera for gesture inputs, and/or another mechanism.

Optionally, the control system 100 may include a drive unit 340 for receiving and reading non-transitory computer media 341 having instructions 342. Additional, different, or fewer components may be included. The processor 300 is configured to perform instructions 342 stored in memory 352 for executing the algorithms described herein. A display 350 may be supported by any of the components described herein. The display 350 may be combined with the user input device 355.

Processor 300 may be a general purpose or specific purpose processor, an application specific integrated circuit (ASIC), one or more programmable logic controllers (PLCs), one or more field programmable gate arrays (FPGAs), a group of processing components, or other suitable processing components. Processor 300 is configured to execute computer code or instructions stored in memory 352 or received from other computer readable media (e.g., embedded flash memory, local hard disk storage, local ROM, network storage, a remote server, etc.). The processor 300 may be a single device or combinations of devices, such as associated with a network, distributed processing, or cloud computing.

Memory 352 may include one or more devices (e.g., memory units, memory devices, storage devices, etc.) for storing data and/or computer code for completing and/or facilitating the various processes described in the present disclosure. Memory 352 may include random access memory (RAM), read-only memory (ROM), hard drive storage, temporary storage, non-volatile memory, flash memory, optical memory, or any other suitable memory for storing software objects and/or computer instructions. Memory 352 may include database components, object code components, script components, or any other type of information structure for supporting the various activities and information structures described in the present disclosure. Memory 352 may be communicably connected to processor 300 via a processing circuit and may include computer code for executing (e.g., by processor 300) one or more processes described herein. For example, memory 298 may include graphics, web pages, HTML files, XML files, script code, shower configuration files, or other resources for use in generating graphical user interfaces for display and/or for use in interpreting user interface inputs to make command, control, or communication decisions.

In addition to ingress ports and egress ports, the communication interface 353 may include any operable connection. An operable connection may be one in which signals, physical communications, and/or logical communications may be sent and/or received. An operable connection may include a physical interface, an electrical interface, and/or a data interface. The communication interface 353 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

While the computer-readable medium (e.g., memory 352) is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Herein, the phrase “coupled with” or “coupled to” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions here before or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed. Furthermore, to the extent that the term “or” is employed (e.g., <A> or <B>) it is intended to mean “<A> or <B> or both.” When the intent is to indicate “only A or B but not both” then the term “only A or B but not both” will be employed.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A pet wash station comprising:
a handshower;
a bath fixture;
an adjustable grate configured to be adjusted to a plurality of heights with respect to the bath fixture; and
a user input device configured to operate the handshower or the adjustable grate.

2. The pet wash station of claim 1, further comprising:
a fur drain configured to catch fur in the drain and pass water past the drain.

3. The pet wash station of claim 1, further comprising
a transparent door configured to open and close a pet entrance to the pet wash station.

4. The pet wash station of claim 1, further comprising
a water sheet supply on a side of the pet wash station, wherein the water sheet supply releases water in a sheet.

5. The pet wash station of claim 1, wherein the user input device configured to operate the handshower and the adjustable grate.

6. The pet wash station of claim 1, wherein the user input device is configured to operate the handshower in at least two modes.

7. The pet wash station of claim 1, wherein the user input device is configured to provide a mechanical lift to set the adjustable grate at the plurality of heights.

8. The pet wash station of claim 1, further comprising:
a manual latch to set the adjustable grate at the plurality of heights.

9. The pet wash station of claim 1, further comprising:
an automatic shutoff device configured to disable the handshower.

10. The pet wash station of claim 1, further comprising:
a soap dispenser configured to release soap to a washing face of the handshower.

11. The pet wash station of claim 1, further comprising:
a dryer configured to provide an air flow to the pet wash station.

12. The pet wash station of claim 1, wherein the user input includes a foot pedal movable in at least two directions.

13. The pet wash station of claim 1, wherein the user input includes a date entry device to receive instructions for the handshower and the adjustable grate.

14. The pet wash station of claim 1, further comprising:
a non-slip mat on the adjustable grate.

15. A method for operating a pet washing station, the method comprising:
setting a height for an adjustable grate;
receiving a user input for a handshower; and
providing water to the handshower in response to the user input.

16. The method of claim 15, further comprising:
detecting that a door to the pet washing station is latched, wherein the water is provided to the handshower in response to the detected latched door.

17. An automatic faucet for providing water to an animal comprising:
a valve configured to selectively control a flow of water through the automatic faucet;
a sensor configured to collect sensor data for the animal in proximity to the automatic faucet; and
a controller configured to identify the animal from the collected sensor data and activate the valve in response to the identified animal.

18. The automatic faucet of claim 17, wherein the controller is configured to compare an image of the animal to at least one template to identify a pet.

19. The automatic faucet of claim 17, wherein the controller is configured to select a valve setting in response to the identified animal, wherein different valve settings correspond to different animals.

20. The automatic faucet of claim 17, wherein the sensor data describes movements of the animal.

21-81. (canceled)
